(19) United States
(12) Patent Application Publication
(10) Pub. No.: US 2006/0293449 A1
(43) Pub. Date: Dec. 28, 2006

(54) Solid filler containing polymerizable compositions, articles formed thereby and methods of formation

(76) Inventors: Rolf Thomas Weberg, East Aurora, NY (US); Charles Francis Desjardins JR., Colden, NY (US); Isabel Echeverria, Amherst, NY (US); Clyde Spencer Hutchins, Colden, NY (US); Richard Reid Gleason JR., Grand Island, NY (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/165,257

(22) Filed: Jun. 23, 2005

(51) Int. Cl. C08L 63/00; B32B 27/38

(52) U.S. Cl. 525/107; 525/438; 525/523; 525/529

(57) ABSTRACT

A polymerizable composition comprises a monoethylenically unsaturated resin, a phosphoric acid ester, an epoxy, a free radical initiator and a filler. The composition is useful in a continuous molding or casting process.

### BACKGROUND OF THE INVENTION

1. Field of the Invention

This invention relates to polymerizable compositions which in a preferred mode are suitable for high volume continuous casting such as for solid surface or engineered stone-type products and to methods for mixing, delivery, and casting of such compositions.

2. Description of the Related Art

Among segments of the cast polymer industry are solid surface and engineered stone materials. As employed herein, a solid surface material represents a uniform, non-gel coated, non-porous, three dimensional solid material containing polymer resin and particulate filler, such material being particularly useful in the building trades for kitchen countertops, sinks and wall coverings wherein both functionality and an attractive appearance are necessary. An example of such solid surface material is sold as Corian® by E. I. du Pont de Nemours and Company.

Solid surface materials often incorporate large decorative particles intended to imitate or resemble the naturally occurring patterns in granite or other natural stones as disclosed in Buser et al in U.S. Pat. No. 4,085,246. However, due to limitations of feasibility and/or practicality of these large decorative particles settling out of the resin during casting, certain decorative patterns and/or categories of decorative patterns have not previously been incorporated in solid surface materials.

The engineered stone market is a rapidly growing market segment in the cast polymer surfacing industry. The bulk of this material consists of a highly mineral-filled (>90wt %) combination with unsaturated polyester resin. An example of such engineered stone material is sold as Zodiaq® by E. I. du Pont de Nemours and Company.

Havriliak U.S. Pat. No. 3,912,773 is directed to a coating resin system which reacts via a vinyl polymerization reaction and cures via an acid-epoxide reaction.

Toncelli in U.S. Pat. No. 4,698,010 discloses the formation of blocks of highly filled compositions by a batch process, conducted completely under vacuum, wherein a material, such as marble or stone, of variable particle size is mixed together with a binder (organic or inorganic) to form a very stiff composition, similar to wet asphalt, that is cured by vibro-compaction.

Wilkinson et al. U.S. Pat. No. 6,387,985 discloses an acrylic and quartz based composition particularly suitable for use as a countertop that is formed through vibro-compaction. Alternatively, the mix may be placed in a casting frame and heated to polymerize the resin.

Hayashi et al. in U.S. Pat. No. 4,916,172 discloses a reaction curable composition and artificial marble obtained by molding and curing the composition. The curable composition comprises a curable component, a polymerization initiator for curing the curable component and from 30 to 90% by weight, based on the total composition, of inorganic fillers, wherein the curable component is a combination of a polyfunctional allylcarbonate monomer or its precondensate, an unsaturated polyester and a reactive diluent, or a combination of a partially cured product of at least two of such three components and the rest of such three components, if any.

While these manufacturing approaches are certainly effective in producing engineered stone materials, there are a number of concerns and limitations. These processes are generally batch preparations that require extensive set up and cleanup operations in order to resume production after completion of a run. The mix is handled several times during process steps which require vacuum evacuation to eliminate entrained air prior to final consolidation and cure, during which volatile resin components can escape. The character of the mixes and the delivery system can change within the consumption of a single batch, creating non-uniformity within and between resulting slabs. The production cycle is non-continuous, creating one slab at a time. Product physical properties can become variable based upon batch cycle and the resulting compositional changes. Attempts to cast engineered stone materials are frustrated by the rate at which stone fillers will settle out of castable resins.

A problem with casting highly filled compositions is that it must have reasonable flow but also not exhibit significant filler settling which directly leads to non-uniformity in the solidified product and in certain cases to formation of a warped product. Attempts to thicken the polymerizable portion on the composition to prevent settling of the filler have the unintended consequence of preventing the deaeration of the entrained air that is inevitable during the mixing of the components. These problems are particularly evident in attempts to continuously cast highly filled compositions.

A need is present for improved compositions and method of formation suitable in manufacture of highly filled casting compositions, which method in a preferred mode is suitable for continuous casting.

### SUMMARY OF THE INVENTION

The present invention is directed to a polymerizable composition comprising:
(i) a monoethylenically unsaturated resin polymerizable by a free radical initiator,
(ii) a phosphoric acid ester,
(iii) an epoxy,
(iv) a free radical initiator,
(v) a solid filler wherein the filler comprises at least 10% and preferably at least 50% by weight of the composition.

The present invention is also directed to a method of preparation to form a polymerized composition.

### DETAILED DESCRIPTION OF THE INVENTION

The present invention is directed to casting or molding a composition containing a solid filler which is not limited to any particular type of casting or molding process, but in a preferred mode is suitable for continuous casting in formation of a cured, i.e., polymerized article.

In continuous casting, the process is characterized by preparation of a highly filled composition which is flowable and cast, such as onto a belt, followed by curing, resulting in polymerization and solidification of such composition. In the case of a continuous casting process it is required that the composition be of a viscosity suitable for pump transfer and general flow. Typically deaeration of the composition is undertaken to avoid entrainment of air prior to polymerization.

The present invention employs a specific composition which in a preferred mode aids in building viscosity when blended and maintaining a similar viscosity during high shear conditions such as mixing and pump transfer, as well as high temperature conditions which typically occur during normal curing. It is desirable that a substantial degree settling of filler be prevented.

A first necessary component in the polymerizable composition is one or more monoethylenically unsaturated resins polymerizable by a free radical initiator. As employed herein resin means at least one of a monomer, oligomer, co-oligomer, polymer, copolymer, or a mixture thereof, including polymer-in-monomer sirups.

A preferred monoethylenically unsaturated resin is derived from an ester of acrylic or methacrylic acid. The ester can be generally derived from an alcohol having 1-20 carbon atoms. Suitable alcohols are aliphatic, cycloaliphatic or aromatic. The ester may also be substituted with groups including, but not limited to, hydroxyl, halogen, and nitro. Representative (meth)acrylate esters include methyl (meth)acrylate, ethyl (methyl)acrylate, butyl (methyl)acrylate, 2-ethylhexyl (meth)acrylate, glycidyl (meth)acrylate, cyclohexo (meth)acrylate, isobornyl (meth)acrylate, and siloxane (methyl)acrylate. Methyl methacrylate is particularly preferred.

Additional examples of monoethylenically unsaturated resins include ones with a vinyl group such as acrylonitrile, methacrylonitrile, and vinyl acetate. Additional polymerizable components in addition to the monoethylenically unsaturated monomers can be employed as is well-known in the art. Illustratively, polyethylenically unsaturated resin monomers are suitable.

A second necessary component is a phosphoric acid ester.

For purposes of illustration phosphoric acid esters include Formulas I to IV as follows:

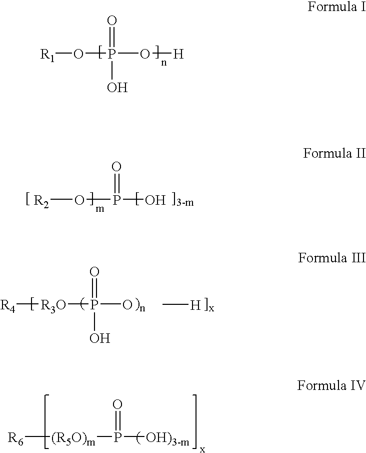

Each of R1 through R6 represents an organic moiety. For purposes of illustration concerning Formulas I and II, R1 and R2 can be aromatic, alkyl, and unsaturated alkyl moieties containing from 6 to 20 carbon atoms. Also for purposes of further illustration R1 and R2 can be an ether or polyether with 4 to 70 carbon atoms and 2 to 35 oxygen atoms.

Concerning Formulas III and IV, R3 and R5 can include aromatic, alkyl, and unsaturated alkyl moieties containing from 1 to 12 carbon atoms. Also for purposes of further illustration R3 and R5 can be an ether or polyether with 1 to 12 carbon atoms and 1 to 6 oxygen atoms, while R4 and R6 can include a polymeric moiety such as acrylic, polyester, polyether and siloxane polymer backbone.

It is understood that in the above formulas, m represents an integer of 1 or 2. The integers n and x can be 1 but include repeating integers such as for n from 1 to 7 and x from 1 to 20.

As further illustration of the scope of phosphoric acid esters are those disclosed in Hayashi et al. U.S. Pat. No. 4,916,172 of the structure: 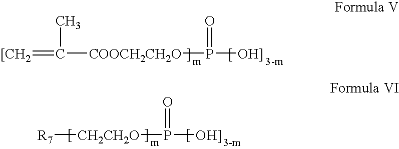
wherein R₇ is an alkyl group having from 8 to 12 carbon atoms and m is an integer of 1 or 2.

A third necessary component is an epoxy. Any one or more of a number of substances with an epoxide group present in the molecule may be employed as the epoxy. Examples of such substances are bisphenol A epoxy; diepoxides; triepoxides; α,β-monoethylenically unsaturated epoxides such as glycidyl methacrylate; an oligomer bearing multiple pendant epoxide groups; a polymer bearing multiple epoxide groups; or combinations thereof. A preferred epoxide is a diepoxide. The diepoxide may be aliphatic, cycloaliphatic, mixed aliphatic and cycloaliphatic and aromatic. The diepoxide may be substituted with halogen, alkyl aryl or sulfur radical. Useful diepoxides are disclosed in Havriliak U.S. Pat. No. 3,912,773. A preferred diepoxide is 3,4-epoxycyclohexylmethyl-3,4-epoxycyclohexane. A further preferred diepoxide is diglycidyl ether of bisphenol A.

A fourth necessary component is a free radical initiator. Either a chemically-activated thermal initiation or a purely temperature-driven thermal initiation to cure the polymerizable components may be employed herein. Both cure systems are well-known in the art. Azo type initiators that thermally decompose may be used and include Vazo® 52, Vazo® 64 and Vazo® 67 (registered trademark of E. I. du Pont de Nemours & Co.).

In a continuous casting process utilizing the composition of the present invention, it has been found beneficial to employ two free radical initiators with different rates of reaction in polymerization of the composition to form a solid article.

In a preferred embodiment of the present invention, it has been unexpectedly discovered that upon initial application of heat, the viscosity of composition does not decrease in a manner which would be expected prior to an increase in viscosity due to polymerization of the resin. This result denotes that highly filled compositions can be employed without a degree of setting of fillers which would otherwise be expected when heating uncured compositions.

The amounts of the four components in the polymerizable composition generally can vary within wide percentages. For purposes of illustration on the basis of these four components (by weight) the monoethylenically unsaturated resin may be from 40 to 80 parts, the phosphoric acid ester may be from 0.1 to 5 parts, the epoxy from 0.1 to 50 parts and the free radical initiator from 0.01 to 2.0 parts. Illustratively, a molar ratio of phosphoric acid ester to epoxy is in a range from 1:4 to 8:1.

Since the present invention is directed to casting of a filled composition, a fifth component, filler, is present in an amount of at least 10% by weight and more preferably at least 50% by weight of the polymerizable composition. Higher percentages are suitable such as at least 80% and or at least 90%. Examples of suitable fillers include particles of unfilled and filled crosslinked or uncrosslinked polymeric material particles, known to the industry as “crunchies”. Such materials generally have a particle size of from about 325 to about 2 mesh (0.04-10.3 mm in greatest average dimension) and can be, for example, pigmented polymethyl methacrylate particles filled with aluminum trihydrate. Other types of fillers include: pigments and dyes; reflective flakes; micas; metal particles; rocks; colored glass; colored sand of various sizes; sea shells; wood products such as fibers, pellets and powders; and others. It is understood that the mineral can be modified such as with an organic material, to modify the rheology. A preferred glass such as for engineered stone-type products includes silica-based materials such as quartz, sand and glass. For engineered stone applications, the filler will generally be present in an amount at least 80% by weight and in many instances in an amount of at least 90% by weight of the total composition. The filler component may be comprised of any one filler or any combination of fillers.

The particle size of the filler may vary, and generally different particle sizes will be employed. Particle size and shape of the solid mineral components allows a desired casting mixture character and delivery of pleasing aesthetics and suitable physical performance. Mixtures of different particulate sizes and shapes can be used to enhance these properties.

Additional components may be added to the polymerizable compositions including those which are conventional in this area of technology. Illustratively, compatibilizing agents may be added to improve the mixing of the compositions. Compatibilizing agents include but are not limited to emulsifiers, surfactants, detergents. Also, polymeric materials may be included which can be copolymers such as random, block and branched copolymers. The additional components can be present to add functional properties to the final polymerized article, and the components may be added solely for decorative or aesthetic properties such as pigments and colorants.

Although the viscosity in the present invention is controlled due to the rapid reaction of the phosphoric ester component with the epoxide component, conventional sag control agents also known as gelling agents in the prior art may optionally be included. Examples are bis urea crystals; cellulose acetate butyrates (CAB); metal organic gellants such as aluminates, titanates, and zirconates; high aspect fibers; polymer powders; filler bridging agents; and fumed silica.

In the process of casting, an unexpected result has been achieved with preferred compositions of the present invention. This unexpected result is that settling of the mineral filler in the liquid composition can be minimized to produce a substantially uniform final article. The minimization of settling allows not only use of a batch process in article formation but more desirably, use of a continuous process. Preferred compositions can be continuously cast onto a single or double belt casting machine, from batch or continuous make up systems. Simple hose delivery or more sophisticated pour boxes, wide nozzles, slot dies or other devices may be used to spread mix uniformly onto the casting surface. This formulation can also be used to charge individual closed or open cells to produce two-dimensional sheet type product or three-dimensional shaped product.

To further illustrate the present invention the following examples are provided. All parts and percentages are by weight and degrees in centigrade unless otherwise indicated.

### COMPARATIVE EXAMPLE 1

A cast engineered stone material was prepared employing an acrylic matrix as follows: 14.6 parts of a 25% acrylic polymer solution (polymethylmethacrylate of molecular weight approximately 30,000 dissolved in methylmethacrylate) were further diluted by 2.2 parts methylmethacrylate. To this diluted solution was added 0.13 parts trimethylolpropane trimethacrylate monomer, 0.15 parts of 2-hydroxyethylmethacrylate acid phosphate, 0.30 parts Foamblast 1326 (air release agent from Lubrizol Corp.), 0.20 parts t-butyl peroxyneodecanoate (75% solution in odorless mineral spirits; Luperox 10M75 from Atofina), and 0.02 parts 2,2′-azobis(methylbutyronitrile) (VAZO 67, from DuPont). This solution was mixed at room temperature to prepare a homogeneous solution. 24.6 parts pulverized quartz solids, 18.8 parts of 84 mesh crushed quartz solids, 51.2 parts of 34 mesh crushed quartz solids, and 0.15 parts of ultra-fine red iron oxide solid pigment were added to the solution with vigorous mixing. When the resulting slurry was homogeneous, 0.25 parts Gamma-methacryloxypropyltrimethoxysilane (A-174, from GE Silicones) was added. This final slurry was mixed under vacuation (23 in. Hg) for 10 minutes. The mix behaved as a power law fluid in a controlled stress rheometer measurement with a consistency 22 Pa s and a rate index of 0.7. Therefore, the slurry represented a slightly shear thinning liquid with a relatively high consistency compared with typical solid surface casting mixes.

After 10 minutes evacuation, the slurry was poured to a thickness of approximately 8 mm into a polyvinyl alcohol film-lined casting box which had been preheated to 80° C. A polyethylene terephthalate sheet was used to cover the poured material and a granite slab also preheated to 80° C. was placed on top. The composition proceeded to cure within twelve minutes as monitored by an embedded thermocouple. The resulting cured sample was allowed to cool to room temperature. The cured sample in the form of a plaque was polished using a standard stone finishing technique to provide a surface of high gloss. The resulting surface was smooth, hard, and exhibited a unique visual depth of field similar to engineered stone materials. However, evidence of filler settling was visually noted and the cast plaque exhibited evidence of material warp upon cooling.

### COMPARATIVE EXAMPLE 2

The composition and procedure to produce a castable engineered stone composition described in Example 1 was repeated. 15 kg of mix was prepared and evacuated. When ready, the mix was continuously poured into an open polyvinyl alcohol gasket casting cell affixed to a lower belt of an experimental double belt casting machine. The double belt casting machine contained the following zones: a feed zone, two heat zones, and an ambient air cooling zone. After pouring to a depth of approximately 0.3 inches, the curable material continuously passed through the various machine zones under the following temperature and time conditions:

| Zone | Temperature (° C.) | Time (min) |
|---|---|---|
| Feed | Ambient | 7 |
| Heat 1 | 85 | 4.25 |
| Heat 2 | 75 | 4.25 |
| Cooling | Ambient | 7 |

Under the above conditions, the material cured within 8.5 minutes upon entry to heat zones 1 and 2. Dimensions of the cast sheet were approximately 32 inches (81 cm) in width and 48 inches (121 cm) in length. Significant warp was observed in addition to air entrainment and air poisoning on the back side of the cast sheet. No adverse particulate pattern effects were noted across the sheet. However, front to back aggregate pattern differences was evident indicating filler settling. The cured sheet was polished using a standard stone finishing technique to provide a surface of high gloss. The resulting surface was smooth, hard, and exhibited a unique visual depth of field quite similar to engineered stone materials.

### EXAMPLE 1

A cast engineered stone mix was prepared employing an acrylic-based matrix as follows: 13.4 parts of a 25% acrylic polymer solution (polymethylmethacrylate with a molecular weight of approximately 30,000, dissolved in methylmethacrylate) were further diluted by 5.4 parts methylmethacrylate. To this diluted solution was added 0.30 part of Foamblast 1326 air release agent (from Lubrizol Corp.), 0.22 part t-butyl peroxyneodecanoate (75% solution in odorless mineral spirits; from Luperox 10M75 from Atofina), 0.03 part 2,2′-azobis(methylbutyronitrile) (VAZO 67, from DuPont), and 0.25 part Gamma-methacryloxypropyltrimethoxysilane (A-174, from GE Silicones). This solution was mixed at room temperature to ensure a homogeneous solution.

The following quartz solids were added to this solution with vigorous mixing: 24.0 parts pulverized quartz solids, 14.0 parts of 84 mesh crushed quartz solids, and 42.0 parts of 34 mesh crushed quartz solids. When all solids were fully wetted to provide a homogeneous mix, 0.15 part of ERL-4221 cycloaliphatic epoxide resin (>82% 7-Oxabicyclo [4.1.0] heptane-3-carboxylic acid, 7-oxabicyclo [4.1.0] hept-3-ylmethyl ester, from Dow Chemical Company) was added. The resulting mixture was evacuated (22 inches water) under agitation for 10 minutes in a laboratory evacuation apparatus. After eight minutes, 0.30 part of 2-hydroxyethylmethacrylate acid phosphate was added to the evacuated mix as a 65% solution in methylmethacrylate.

After addition of the 2-hydroxyethylmethacrylate acid phosphate, the mix behaved as a power law fluid in a controlled stress rheometer measurement with a consistency of 47 Pa s and a rate index of 0.43. Therefore, the solution represented a more shear thinning liquid and maintained a relatively high consistency compared with Comparative Example 1 and characteristic solid surface casting mixes. Before addition of the 2-hydroxyethylmethacrylate acid phosphate, the solution exhibited a low shear rate viscosity on the order of 7 times lower than the final solution.

The casting solution was poured to a thickness of approximately 8 mm into a polyvinyl alcohol film-lined casting box which had been preheated to 80° C. A polyethylene terephthalate sheet was used to cover the poured material and a granite slab preheated to 80° C. was placed on top. The composition proceeded to cure within twelve minutes as monitored by an embedded thermocouple. The resulting cured sample was allowed to cool to room temperature. After cooling, the cured sample as a plaque exhibited improved resistance to filler settling and material warp compared to Comparative Example 1. In addition, air entrainment was reduced. The material was polished using a standard stone finishing technique to provide a surface of high gloss. The resulting surface was smooth, hard, and exhibited a visual depth of field similar to engineered stone materials.

### EXAMPLE 2

The composition and procedure to produce a castable engineered stone composition as described in Example 1 was repeated. Approximately 15 kg of mix was prepared and evacuated. When ready, the mix was continuously poured into an open gasket casting cell affixed to the lower belt of an experimental double belt casting machine. The double belt casting machine contained the following zones: a feed zone, two heat zones, and an ambient air cooling zone. After pouring to a depth of approximately 0.3 inches, the curable material continuously passed through the various machine zones under the following temperature and time conditions:

| Zone | Temperature (° C.) | Time (min) |
|---|---|---|
| Feed | Ambient | 3.8 |
| Heat 1 | 65 | 6.5 |
| Heat 2 | 75 | 6.5 |
| Cooling | Ambient | 7 |

Under the above conditions, the cast mix cured within 13 minutes upon entering zones 1 and 2. The resulting sheet (approximately 30 inches (76 cm) by 50 inches (127 cm)) exhibited an improved back side surface regarding air entrainment and air poisoning; evacuation of the initial mix was enhanced versus Comparative Example 1. The cured sheet was finished using a standard stone finishing technique to provide a surface of high gloss. The resulting surface was smooth, hard, and exhibited a visual depth of field quite similar to engineered stone materials.

### EXAMPLE 3

A continuously cast engineered stone mix employing an acrylic-based resin matrix was prepared as follows: 13.3 parts of a 25% acrylic polymer solution (polymethylmethacrylate with a molecular weight of approximately 30,000, dissolved in methylmethacrylate) which was further diluted by 4.6 parts methylmethacrylate. To this diluted solution was added 0.30 part Foamblast 1326 air release agent (from Lubrizol Corp.), 0.19 part t-butyl peroxyneodecanoate (75% in odorless mineral spirits; Luperox 10M75 from Atofina), 0.02 part 2,2′-azobis(methylbutyronitrile) (VAZO 67 from DuPont), and 0.25 part Gamma-methacryloxypropyltrimethoxysilane (A-174, GE Silicones). This solution was mixed at room temperature to ensure a homogeneous solution.

The following quartz solids were added to this solution with vigorous mixing: 24.0 parts pulverized quartz solids, 14.0 parts of 84 mesh crushed quartz solids, and 42.0 parts of 34 mesh crushed quartz solids. When all solids were fully wetted to provide a homogeneous mix, 0.40 part of 2-hydroxyethylmethacrylate acid phosphate was added with high shear mixing. After one minute, 0.56 part of Solplus D-520 phosphated copolymer (from Noveon, Inc.) was added under high shear mixing. After an additional minute, 0.38 part of ERL-4221 cycloaliphatic epoxide resin (>82% 7-Oxabicyclo [4.1.0] heptane-3-carboxylic acid, 7-oxabicyclo [4.1.0] hept-3-ylmethyl ester, from Dow Chemical Company) was added. The resulting mixture was evacuated (22 inches water) under agitation for 10 minutes in a laboratory evacuation apparatus.

After addition of the cycloaliphatic epoxide resin, the mix behaved as a power law fluid in a controlled stress rheometer measurement with a consistency of 37 Pa s and a rate index of 0.46. Therefore, the solution represented a more shear thinning liquid versus Comparative Example 1 and similar to Example 1, but maintaining a consistency intermediate those two comparative examples. These characteristics translated into more efficient evacuation and enhanced material transfer and laydown capabilities without severe air entrainment.

The evacuated casting solution was poured to a thickness of approximately 8 mm into a polyvinyl alcohol film-lined casting box which had been electrically preheated to 80° C. A polyethylene terephthalate used to cover the poured material and an electrically heated plate was placed on top. The composition proceeded to cure within twelve minutes as monitored by an embedded thermocouple. The resulting cured sample was allowed to cool to room temperature. The cured sample as a plaque was finished using a standard stone finishing technique to provide a surface of high gloss. The resulting surface was smooth, hard, and exhibited a unique visual depth of field quite similar to engineered stone materials.

### EXAMPLE 4

The composition and procedure to produce a castable engineered stone composition as described in Example 3 was repeated. Approximately 70 kg of mix was prepared and evacuated. When ready, the mix was continuously poured into an open gasket casting cell affixed to the lower belt of an experimental double belt casting machine. The double belt casting machine contained the following zones: a feed zone, two heat zones, and two cooling zones. After continuously pouring to a depth of approximately 0.3 inches (0.76 cm), the curable material passed through the various machine zones under the following temperature and time conditions:

| Zone | Temperature (° C.) | Time (min) |
|---|---|---|
| Feed | Ambient | 3 |
| Heat 1 | 70 | 4.5 |
| Heat 2 | 85 | 7.5 |
| Cooling 1 | 60 | 7.5 |
| Cooling 2 | 37 | 12.5 |

Under the above conditions, the cast mix cured within 11.5 minutes upon entering the heat zone. The resulting sheet (approximately 38 inches (96 cm) by 80 inches (203 cm)) exhibited an improved back side surface regarding air entrainment and a determination of air poisoning indicating that evacuation and material flow of the casting mix was enhanced versus Examples 2 and 4. In addition, the cast sheet exhibited little or no warp (<0.02 inches (0.5 mm)) as compared to earlier examples. The cured sheet was finished using a standard stone finishing technique to provide a surface of high gloss. The resulting surface was smooth, hard, and exhibited a unique visual depth of field quite similar to engineered stone materials.

### EXAMPLE 5

A cast solid surface material was prepared employing an acrylic matrix as follows: 22.5 parts of a 25% acrylic polymer solution (polymethylmethacrylate with a molecular weight of approximately 30,000, dissolved in methylmethacrylate) were further diluted by 10.6 parts methylmethacrylate. To this diluted solution were added 0.3 part trimethylolpropane trimethacrylate monomer (SR-350, from Sartomer Company); 0.07 part Zelec PH unsaturated phosphoric acid ester (from Stepan Company); 0.15 part dioctylsulfosuccinate, sodium salt (about 75% in a mineral spirits carrier); 0.35 part of t-butyl peroxyneodecanoate (75% solution in odorless mineral spirits; Luperox 10M75 from Atofina), and 0.04 part 2,2′-azobis(methylbutyronitrile) (VAZO 67, from E. I. du Pont de Nemours Company). This solution was mixed at room temperature to prepare a homogeneous solution. Then 44.0 parts of alumina trihydrate (ATH) and 22.0 parts of alumina trihydrate-filled acrylic solid surface crunchies in particle sizes ranging from 4 to 150 mesh were added under high shear.

The mixture was evacuated at 22 inches of mercury in a laboratory evacuator fitted with a condensing column for five minutes. After evacuation, the mixture was poured into a polyvinyl alcohol-lined casting box that had been preheated to 80° C. When poured, a cover also heated to 80 C. was placed on top. Thermal cure profile was measured via an implanted thermocouple.

The resulting plaque exhibited significant filler settling. Nearly all of the ATH-filled acrylic crunchies were collected on the face side (down). The back side (up) was low in filler content and exhibited significant monomer boil defect.

### EXAMPLE 6

A cast solid surface material was prepared employing an acrylic matrix as follows: 22.0 parts of a 25% acrylic polymer solution (polymethylmethacrylate with a molecular weight of approximately 30,000, dissolved in methylmethacrylate) were further diluted by 10.3 parts methylmethacrylate. To this diluted solution were added 0.29 part trimethylolpropane trimethacrylate monomer (SR-350, from Sartomer Company); 0.60 part Zelec PH unsaturated phosphoric acid ester (from Stepan Company); 0.15 part dioctylsulfosuccinate, sodium salt (˜75% in a mineral spirits carrier); 0.35 part of t-butyl peroxyneodecanoate (75% solution in odorless mineral spirits; Luperox 10M75 from Atofina), 0.04 part 2,2′-azobis(methylbutyronitrile) (VAZO 67, from E. I. du Pont de Nemours Company), and 0.30 part of ERL-4221 aliphatic epoxy resin (from Dow Chemical). This solution was mixed at room temperature to prepare a homogeneous solution. 44.0 parts alumina trihydrate, and 22.0 parts of alumina trihydrate-filled acrylic solid surface particulate mixture comprised of particle sizes ranging from 4 to 150 mesh were added under high shear.

The mixture was evacuated at 22 inches of mercury in a laboratory evacuator fitted with a condensing column for five minutes. After evacuation, the evacuated mixture was poured into a polyvinyl alcohol-lined casting box that had been preheated to 80° C. A heated cover, also heated to 80° C., was placed on top. Thermal cure profile was measured via an implanted thermocouple.

The resulting plaque exhibited homogeneous distribution of ATH-filled acrylic aggregate particles throughout the material.

### EXAMPLE 7

A cast solid surface material was prepared employing an acrylic matrix as follows: 20.7 parts of a 25% acrylic polymer solution (polymethylmethacrylate with a molecular weight of approximately 30,000, dissolved in methylmethacrylate) were further diluted by 9.6 parts methylmethacrylate. To this diluted solution were added 0.28 part trimethylolpropane trimethacrylate monomer (SR-350, from Sartomer Company); 0.60 part Zelec PH unsaturated phosphoric acid ester (from Stepan Company); 0.15 part dioctylsulfosuccinate, sodium salt (˜75% in a mineral spirits carrier); 1.11 parts t-butyl peroxymaleic acid (PMA-25, from Atofina), and 0.30 part of ERL-4221 aliphatic epoxy resin (from Dow Chemical). This solution was mixed at room temperature to prepare a homogeneous solution. 44.0 parts alumina trihydrate and 22.0 parts of alumina trihydrate-filled acrylic solid surface particulate mixture comprised of particle sizes ranging from 4 to 150 mesh were added under high shear.

The mixture was evacuated at 22 inches of mercury in a laboratory evacuator fitted with a condensing column for a total of three minutes. During the last 40 seconds of evacuation, three activator solutions were injected by syringe into the solution in rapid succession: 1.0% parts calcium hydroxide dispersion; 0.17 part ethylene glycol dimercaptoacetate; and 0.10 part distilled water. After evacuation, the evacuated mixture was poured into a polyvinyl alcohol-lined casting box that had been preheated to 40° C. Thermal cure profile was measured via an implanted thermocouple.

The resulting sample as a plaque exhibited homogeneous distribution of ATH-filled acrylic aggregate particles throughout the material as compared to control material not containing the epoxy resin system which exhibited aggregate filler settling.

What is claimed is:

1. A polymerizable composition comprising:
(i) a monoethylenically unsaturated resin polymerizable by a free radical initiator,
(ii) a phosphoric acid ester,
(iii) an epoxy,
(iv) a free radical initiator,
(v) a solid filler wherein the filler comprises at least 10% by weight of the composition.

2. The composition of claim 1 wherein the resin comprises a polyester.

3. The composition of claim 1 wherein the resin comprises an acrylate.

4. The composition of claim 3 wherein the acrylate is methyl methacrylate.

5. The composition of claim 1 which contains at least 50% filler.

6. The composition of claim 5 which contains at least 80% filler.

7. The composition of claim 6 wherein the filler comprises a mineral.

8. The composition of claim 1 wherein on the basis by weight of (i), (ii), (iii) and (iv), (i) is present in a range from 40 to 80 parts, (ii) is present in a range from 0.1 to 5 parts, (iii) is present in a range from 0.1 to 50 parts, (iv) is present in a range from 0.1 to 2.0 parts.

9. The composition of claim 1 wherein the molar ratio of phosphoric acid ester to epoxy is in a range from 1:4 to 8:1.

10. A polymerized article formed by the composition of claim 1.

11. The polymerized article of claim 10 as a countertop.

12. A method for casting or molding a polymerizable composition comprising:
(a) mixing a composition comprised of:
(i) a monoethylenically unsaturated resin polymerizable by a free radical initiator,
(ii) a phosphoric acid ester,
(iii) an epoxy,
(iv) a free radical initiator,
(v) a solid filler wherein the filler comprises at least 10% by weight of the composition.
(b) casting or molding the composition; and
(c) curing the composition.

13. The method of claim 12 wherein the resin comprises a polyester.

14. The method of claim 12 wherein the resin comprises an acrylate.

15. The method of claim 14 wherein the acrylate is methyl methacrylate.

16. The method of claim 12 wherein the filler comprises at least 50% of the composition.

17. The method of claim 12 wherein the filler is at least 80% of the composition.

18. The method of claim 13 wherein the filler comprises a mineral.

19. The method of claim 12 which employs at least two free radical initiators with different rates of reaction.

20. The method of claim 19 which employs thermal initiation curing.

21. The method of claim 12 wherein said composition is cast onto a moving belt.
